(19) United States
(12) Patent Application Publication
(10) Pub. No.: US 2026/0138211 A1
(43) Pub. Date: May 21, 2026

(54) DEBRIS REMOVAL MODULE FOR LASER GROOVING APPARATUS, AND LASER GROOVING APPARATUS INCLUDING THE SAME

(71) Applicant: TAIWAN SEMICONDUCTOR MANUFACTURING COMPANY, LTD., Hsinchu (TW)

(72) Inventors: Ting-Jyun JIANG, Hsinchu (TW); Yung-Tsun LIU, Hsinchu (TW); Kuang-Wei CHENG, Hsinchu (TW)

(73) Assignee: TAIWAN SEMICONDUCTOR MANUFACTURING COMPANY, LTD., Hsinchu (TW)

(21) Appl. No.: 18/951,910

(22) Filed: Nov. 19, 2024

(51) Int. Cl. B23K 26/142; B23K 26/364

(52) U.S. Cl. CPC B23K 26/142; B23K 26/364

(57) ABSTRACT

A debris removal module is adapted for a laser grooving apparatus configured to perform laser grooving on a wafer. The debris removal module includes a purge module and an exhaust module. The purge module includes a nozzle to expel a purge gas. The exhaust module has a debris entry opening disposed to receive debris generated from the wafer during the laser grooving, a purge opening disposed to receive the purge gas from the nozzle, and an exhaust channel disposed to exhaust the debris. The debris entry opening, the purge opening and the exhaust channel are in spatial communication. The nozzle has a gas outlet that faces the purge opening of the exhaust module, is elongated in shape, and is configured to expel the purge gas through the gas outlet to push the debris toward the exhaust channel.

### BACKGROUND

In the semiconductor industry, a laser grooving process is critical for separating individual dies on a wafer while minimizing damage to surrounding areas. A laser grooving apparatus is used to precisely cut or etch grooves in semiconductor wafers, and utilizes a focused laser beam to create clean, narrow grooves with high precision, enhancing yield and reducing material waste during wafer dicing. Laser grooving plays a key role in preparing semiconductor components for packaging and assembly.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a laser grooving apparatus in accordance with a first embodiment.

FIG. 2 is a schematic diagram illustrating a wafer used in laser grooving in accordance with some embodiments.

FIG. 3 is a perspective view illustrating a purge module in accordance with some embodiments.

FIG. 4 is a perspective view illustrating a purge component in accordance with the first embodiment.

FIG. 5 is a perspective view illustrating an exhaust module in accordance with some embodiments.

FIGS. 6 and 7 are simulation diagrams illustrating flow of a purge gas in accordance with the first embodiment.

FIG. 8 is a simulation diagram illustrating paths of gas particles in accordance with the first embodiment.

FIG. 9 is a schematic diagram illustrating a laser grooving apparatus in accordance with a second embodiment.

FIG. 10 is a perspective view illustrating a purge component in accordance with the second embodiment.

FIG. 11 is a schematic diagram illustrating a laser grooving apparatus in accordance with a third embodiment.

FIG. 12 is a perspective view illustrating a purge component in accordance with the third embodiment.

FIG. 13 is a front view illustrating a nozzle portion of the purge component in accordance with the third embodiment.

FIG. 14 is a schematic diagram illustrating some relationships between the nozzle portion of the purge component and a purge opening of the purge module in accordance with some embodiments.

FIGS. 15 and 16 are simulation diagrams illustrating flow of a purge gas in accordance with the third embodiment.

FIG. 17 is a simulation diagram illustrating paths of gas particles in accordance with the third embodiment.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “on,” “above,” “over,” “downwardly,” “upwardly,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some aspects ±10%, in some aspects ±5%, in some aspects ±2.5%, in some aspects ±1%, in some aspects ±0.5%, and in some aspects ±0.1% from the specified amount, as such variations are appropriate to perform the disclosed methods or employ the disclosed compositions.

Laser grooving is used to create shallow grooves or channels on the surface of a semiconductor wafer. The grooves define scribe lines or streets where the wafer will later be separated into individual dies or chips. The laser grooving process helps to minimize mechanical stress and potential damage during the subsequent dicing process, especially when using mechanical sawing. A pulsed laser is commonly used in the laser grooving process to offer precise control and minimize thermal damage to the wafer. A laser module focuses a laser beam onto the wafer surface along predefined paths (i.e., scribe lines), and the energy from the laser ablates the material, thereby creating a narrow, precise groove. By creating grooves, the subsequent mechanical dicing process induces less stress on the wafer, reducing the risk of cracks or chipping. However, as the laser removes material from the wafer, rapid vaporization and expulsion of material may generate debris, which may include, for example, debris particles, melted materials, gaseous byproduct, etc. The debris may settle on the wafer surface and/or may be condensed on a lens of the laser module, resulting in contamination of device layers and/or the lens, and thus affecting subsequent processing steps.

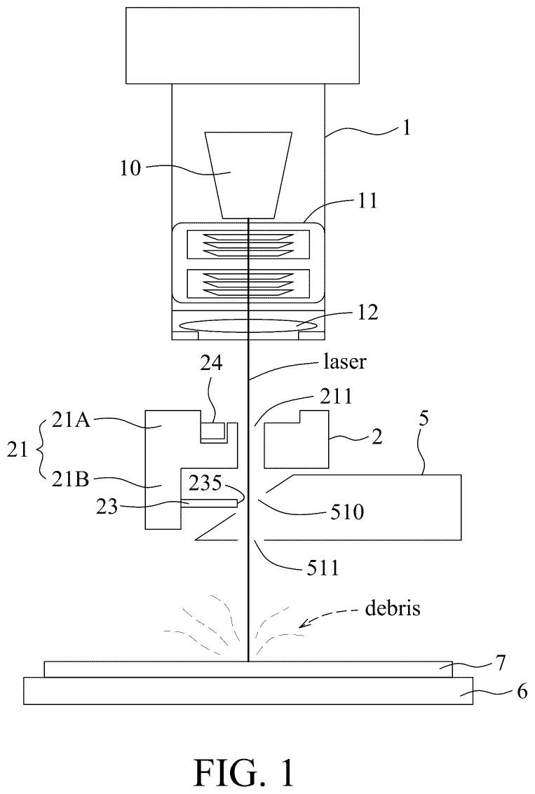

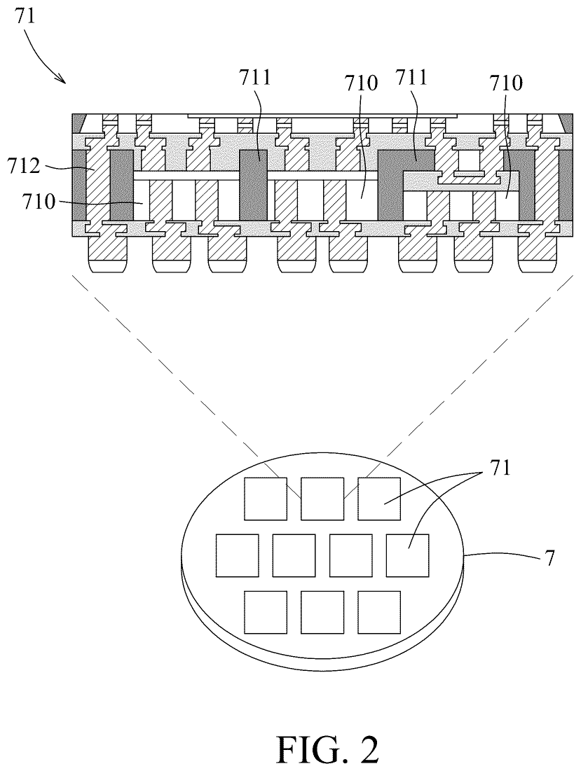

FIG. 1 illustrates a laser grooving apparatus in accordance with a first embodiment. The laser grooving apparatus is adapted to perform laser grooving, and includes a laser module 1, a purge module 2, an exhaust module 5 and a wafer stage 6. The wafer stage 6 is disposed below the laser module 1, the purge module 2 and the exhaust module 5, and is configured to hold a wafer 7 during the laser grooving. Further referring to FIG. 2, the wafer 7 may be formed with multiple dies 71 thereon. Each of the dies 71 may include, for example, multiple types of integrated circuits 710 that provide various functions, moldings 711 that isolate the integrated circuits 710 from each other, and through-insulator vias (TIVs) 712 that pass through some of the moldings 711 to provide required electrical connection, etc., but this disclosure is not limited in this respect. The laser module 1 includes a laser source 10, a lens assembly 11 and a protective lens 12. The laser source 10 is configured to generate a laser beam, and may be, for example, a nanosecond pulsed laser, a picosecond pulsed laser, etc., but this disclosure is not limited in this respect. The lens assembly 11 is configured to shape, focus, and deliver the laser beam with precision, and may include, for example but not limited to, collimating lenses, focusing lenses, beam expanders, other suitable lenses, or any combination thereof. The protective lens 12 is disposed downstream in a beam path after the lens assembly 11, thereby protecting the lens assembly 11 from contamination by debris. Although the protective lens 12 is replaceable after being contaminated, frequently changing the protective lens 12 may lead to increased downtime and potentially disrupting production schedules, so there is a need to effectively remove the debris generated during the laser grooving for reducing the frequency of changing the protective lens 12. In the illustrative embodiment, the purge module 2 and the exhaust module 5 cooperatively form a debris removal module that is configured to remove the debris generated during the laser grooving process, so as to minimize the contamination and the frequency of changing the protective lens 12.

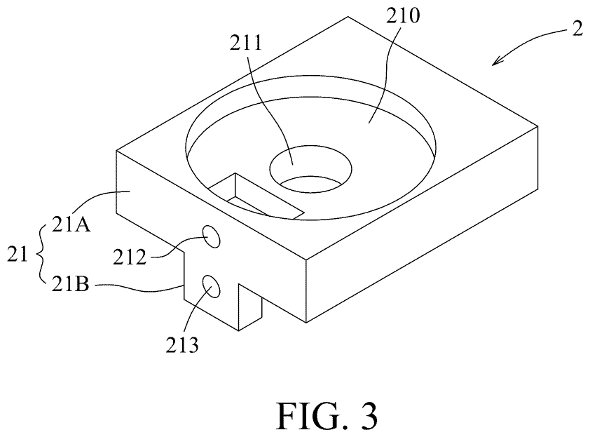

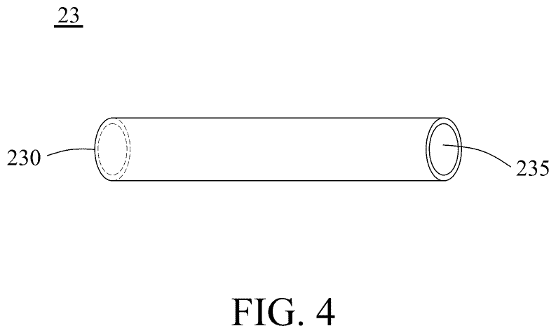

Referring to FIGS. 1 and 3, the purge module 2 is disposed under the laser module 1 and above the exhaust module 5, and includes a base 21, a purge component 23 connected to the base 21, and a diffuser 24 connected to the base 21. In the illustrative embodiment, the base 21 includes a shield portion 21A, and an extending portion 21B that extends downward from an edge portion of the shield portion 21A. The shield portion 21A extends laterally (e.g., parallel to a surface of the wafer stage 6), and is positioned between the laser module 1 and the exhaust module 5, thereby blocking some of the debris that escapes from the exhaust module 5 from reaching the laser module 1, so as to reduce contamination of the protective lens 12. The shield portion 21A has a rear surface formed with a pipe connection port 212, and has a top surface formed with a circular groove 210. The pipe connection port 212 is configured for connection with a pipe (not shown) for receiving a gas (e.g., clean dry air, nitrogen gas, other suitable gases, or any combination thereof) from a gas source (not shown) through the pipe. The circular groove 210 has a bottom surface formed with a through hole 211 that is aligned with a laser aperture of the laser module 1 in a vertical direction, allowing passage of the laser beam through the purge module 2 during the laser grooving process. In the illustrative embodiment, the bottom surface of the circular groove 210 is further formed with a groove between the through hole 211 and the rear surface of the shield portion 21A. The groove has a sidewall formed with a diffuser connection port (not shown from the perspective of FIG. 3). The diffuser connection port spatially communicates with the pipe connection port 212, and is configured for engaging with the diffuser 24, so the diffuser 24 receives the gas from the gas source through the pipe that is connected to the pipe connection port 212. In accordance with some embodiments, the diffuser 24 has a porous surface for expelling the gas in all directions, and the gas expelled by the diffuser 24 flows downward toward the through hole because of a suction force from the exhaust module 5, thereby preventing the debris from rising and passing through the through hole 211, and thus reducing contamination of the protective lens 12. The extending portion 21B has a pipe connection port 213 and a nozzle connection port (not shown from the perspective of FIG. 3) that are in spatial communication and formed respectively on a rear surface and a front surface of the extending portion 21B. The pipe connection port 213 is configured for connection with a pipe (not shown) for receiving a purge gas from a gas source (not shown) through the pipe. In accordance with some embodiments, the purge may be clean dry air (CDA), nitrogen gas, other suitable gases, or any combination thereof. The nozzle connection port is configured for engaging with the purge component 23, so the purge component 23 receives the purge gas from the gas source through the pipe. In this embodiment, as illustrated in FIG. 4, the purge component 23 is a straight tube serving as a nozzle and having a circular gas inlet 230 (i.e., an opening from which the purge gas enters the purge component 23) and a circular gas outlet 235 (i.e., an opening where the purge gas is expelled from the purge component 23). The purge component 23 extends horizontally (i.e., parallel to the surface of the wafer stage 6) when being connected to the nozzle connection port, so the gas expelled from the purge component 23 goes horizontally.

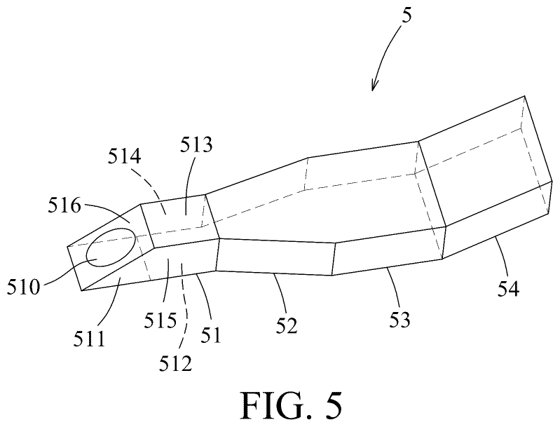

Referring to FIGS. 1 and 5, the exhaust module 5 is disposed above the wafer stage 6, and is an airflow duct formed by, for example, a metallic shell. In the illustrative embodiment, the exhaust module 5 includes a debris entry portion 51, an expanding portion 52, an intermediate portion 53, and a connecting portion 54, each defining an inner space. The portions 51 to 54 are connected in series to make their inner spaces in spatial communication, thereby forming an exhaust channel extending from the debris entry portion 51 to the connecting portion 54. The debris entry portion 51 has a purge opening 510 disposed to receive the purge gas expelled from the purge component 23, and a debris entry opening 511 for receiving the debris from the wafer 7 during the laser grooving. In the illustrative embodiment, the debris entry opening 511 is disposed under the purge opening 510 and thus is closer to the wafer stage 6 than the purge opening 510. The purge opening 510, the debris entry opening 511 and the exhaust channel are in spatial communication, and the purge gas that passes through the purge opening 510 pushes the debris that passes through the debris entry opening 511 toward a distal end of the exhaust channel, thereby removing the debris from the laser grooving apparatus. Moreover, the purge opening 510 and the debris entry opening 511 are, at least in part, aligned with the laser aperture of the laser module 1 in the vertical direction, allowing the laser beam that has penetrated the through hole 211 of the purge module 2 to pass through the exhaust module 5 and then reach the wafer 7 during the laser grooving process. In the illustrative embodiment, the debris entry portion 51 has a bottom plate 512 formed with the debris entry opening 511, a top plate 513, a pair of side plates 514, 515 opposite to each other and interconnecting the bottom plate 512 and the top plate 513, and a gas entry plate 516 formed with the purge opening 510. Each of the side plates 514, 515 has an upper edge shorter than its lower edge, and a sloping edge connecting the upper edge and the lower edge. The gas entry plate 516 is slanted (i.e., neither parallel nor vertical to the surface of the wafer stage 6), extends between the sloping edges of the side plates 514, 515, and has a slanted surface facing obliquely upward toward the gas outlet 235 (see FIG. 4) of the purge component 23. Accordingly, the purge opening 510 is slanted relative to the debris entry opening 511, which is parallel to the surface of the wafer stage 6 in the illustrative embodiment, and a vertical height of the purge opening 510 is greater than a diameter of the gas outlet 235 of the purge component 23. In some embodiments, the debris entry portion 51 may be a cuboid, so the gas entry plate 516 would be a vertical plate with a surface facing the purge component 23. In this case, the top plate 513 may be formed with an opening aligned with the laser aperture of the laser module 1 and the debris entry opening 511, so the laser beam can reach the wafer 7 through that opening and the debris entry opening 511, and the purge gas may push the debris toward the exhaust channel through the purge opening 510 at the lateral side. On the other hand, forming the gas entry plate 516 as a slanted surface and using the slanted purge opening 510 for passage of both the laser beam and the purge gas may reduce dead zones in the debris entry portion 51, thereby minimizing accumulation of debris in the debris entry portion 51. In accordance with some embodiments, a center of the purge opening 510 is aligned with a center of the gas outlet 235 of the purge component 23 in a direction the purge component 23 extends (i.e., a horizontal direction parallel to the surface of the wafer stage 6 in this embodiment). The expanding portion 52 has a first end connected to an end of the debris entry portion 51 that is opposite to the gas entry plate 516, and a second end opposite to the first end. In the illustrative embodiment, the expanding portion 52 has a sectional area gradually increasing from the first end to the second end. In detail, the expanding portion 52 has a substantially constant height and a gradually increasing width, so an opening of the second end is larger than an opening of the first end. The expanding width of the expanding portion 52 may prevent turbulent flow and backpressure and reduce the concentration of gas flow, thereby ensuring a smoother and more controlled exhaust process and allowing for more efficient venting and/or filtration. The intermediate portion 53 is connected between the second end of the expanding portion 52 and the connecting portion 54, and has a substantially constant width. The connecting portion 54 is configured for connection to another device, such as a pump that is used to extract the mixture of the purge gas and the debris from the exhaust channel. In practice, the debris entry portion 51, the expanding portion 52 and the intermediate portion 53 may extend in the same direction, whereas the connecting portion 54 may extend in a different direction depending on a position of the device to be connected with. In accordance with some embodiments, either the expanding portion 52 or the intermediate portion 53 may be omitted.

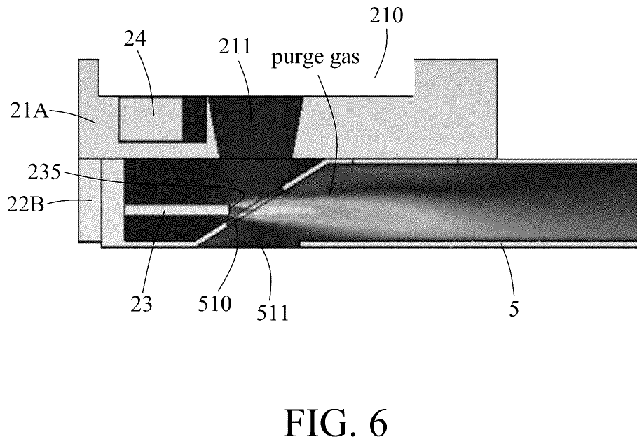

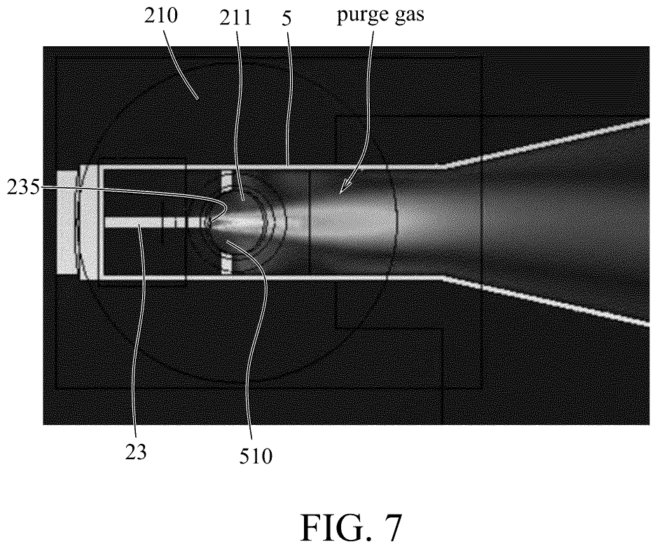

FIG. 6 and FIG. 7 are sectional views of the purge module 2 and the exhaust module 5 observed respectively from a lateral side and a top side, simulating a flow of the purge gas expelled from the purge component 23 of the first embodiment (see FIGS. 1 and 4). Since the purge component 23 is a straight tube having a uniform diameter and extending horizontally, the purge gas is expelled forward as an air column and expands slowly.

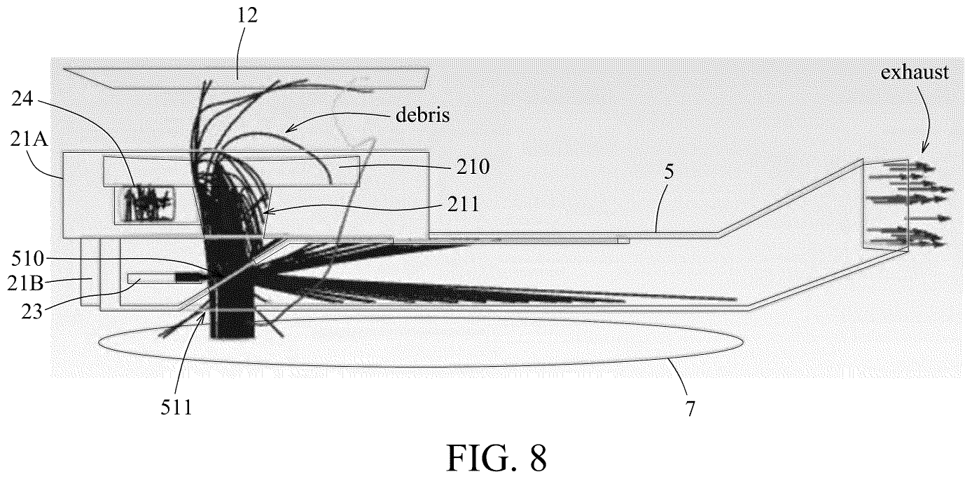

FIG. 8 is a sectional view of the purge module 2 and the exhaust module 5 of the first embodiment observed from a lateral side, simulating paths of gas particles that include the gas from the diffuser 24, the purge gas from the purge component 23, and the debris generated during the laser grooving process. The debris is ejected upward and enters the exhaust module 5 through the debris entry opening 511. The purge component 23 horizontally outputs the purge gas into the exhaust module 5 through the purge opening 510 to push a part of the debris toward the exhaust channel, and cooperates with the pump (not shown) to remove the debris. The remaining part of the debris continues to go upward, thereby escaping from the exhaust module 5 through the purge opening 510 and entering the through hole 211 of the purge module 2. The gas outputted by the diffuser 4 and the design of the groove 210 creates a downward gas flow that flows into the through hole 211, blocking some of the debris from continuing upward. Eventually, only a small portion of the debris can reach the protective lens 12. It is noted that this simulation uses a picosecond pulsed laser as the laser module 1. In practice, the picosecond pulsed laser may produce more severe debris contamination because its shorter pulse width requires higher energy to achieve a similar grooving effect. Therefore, when a nanosecond pulsed laser is used as the laser module 1, there would be even less debris reaching the protective lens 12.

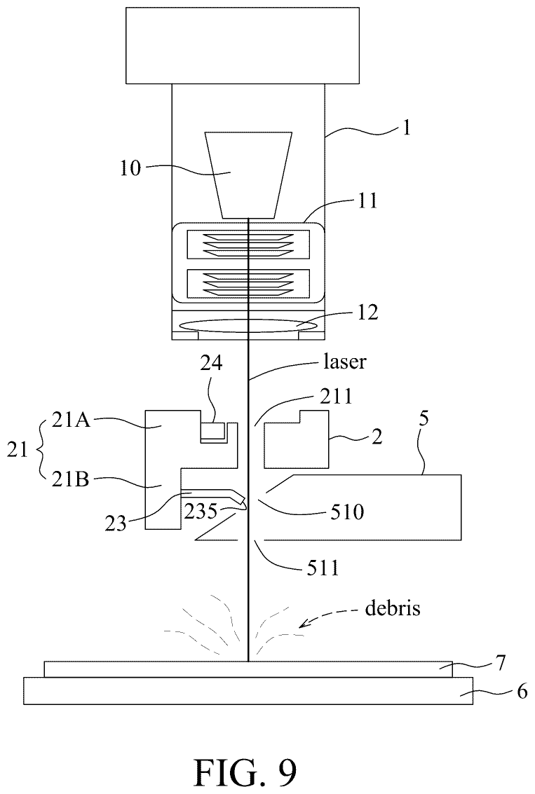

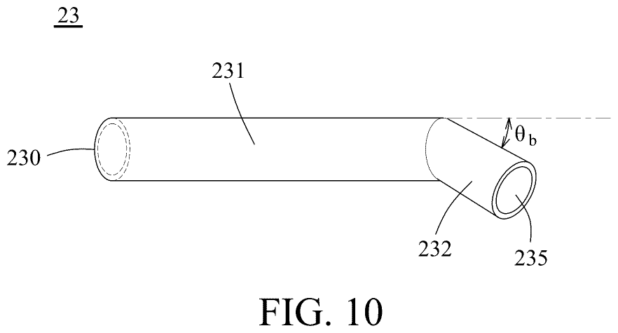

FIG. 9 illustrates a laser grooving apparatus in accordance with a second embodiment. The second embodiment is similar to the first embodiment, and differs from the first embodiment in that, as illustrated in FIG. 10, the purge component 23 of the second embodiment has a first straight tube portion 231, and a second straight tube portion 232 that is connected to the first straight tube portion 231 at an angle (namely, extending obliquely from the first straight tube portion 231). The first straight tube portion 231 has a circular gas inlet 230 of the purge component 23 and is configured to deliver the purge gas that is received from the gas source through the gas inlet 230 to the second straight tube portion 232. The second straight tube portion 232 serves as a nozzle and has a circular gas outlet 235 of the purge component 23. The first straight tube portion 231 and the second straight tube portion 232 have substantially the same diameter, namely, the purge component 23 has a uniform cross-sectional area. When the purge component 23 is installed to the extending portion 21B of the purge module 2, the first straight tube portion 231 is parallel to the wafer stage 6, and the second straight tube portion 232 extends obliquely downward toward the center of the purge opening 211 (i.e., the center of the gas outlet 235 of the purge component 23 being aligned with the center of the purge opening 510 in a direction the second straight tube portion 232 extends). As a result, the purge component 23 is positioned higher than the center of the purge opening 510 in its entirety. This configuration causes the purge gas to be expelled downward at an angle, entering the exhaust module 5 and pushing the debris diagonally downward into the exhaust channel. The downward flow of the purge gas can weaken the upward movement of the debris, thereby further reducing contamination of the protective lens 12. In accordance with some embodiments, taking into account a distance between the purge component 23 and the shield portion 21A of the purge module 2, a distance between the exhaust module 5 and the shield portion 21A of the purge module 2, and a distance between the purge component 23 and the purge opening 510, a bending angle θ_{b} of the purge component 23 (i.e., an angle between the second straight tube portion 232 and an extension line of the first straight tube portion 231) may be in a range from about 26 degrees to about 55 degrees. In accordance with some embodiments, an extension line of the second straight tube portion 232 extends across the debris entry opening 511 and intersects the bottom plate 512 (see FIG. 5) of the exhaust module 5, so the purge gas expelled from the second straight tube portion 232 would not pass through the debris entry opening 511 and would land on the bottom plate 512 of the exhaust module 5, thereby preventing the debris from being blown back onto the wafer 7 during the laser grooving.

In a variation of the second embodiment, the first straight tube portion 231 may be omitted, the purge component 23 is a straight tube, and the purge module 2 is configured in such a way that, when the purge component 23 is installed to the extending portion 21B of the purge module 2, the purge component 23 extends obliquely downward toward the purge opening 510.

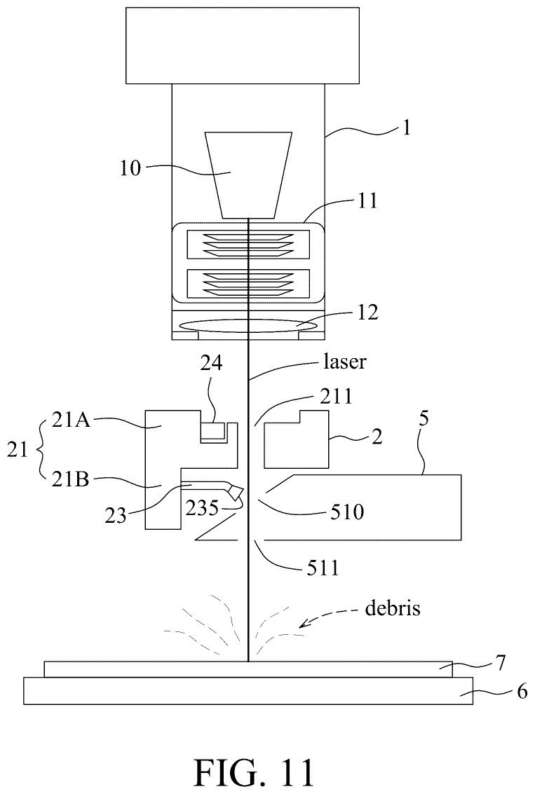

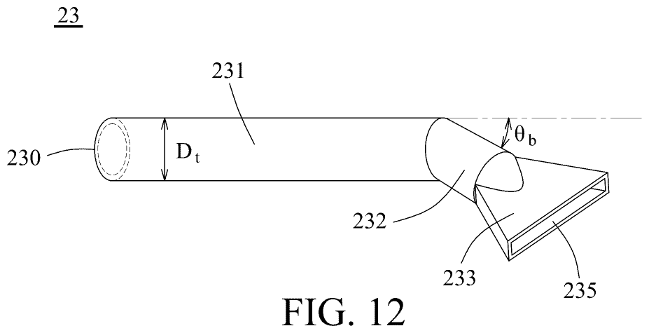

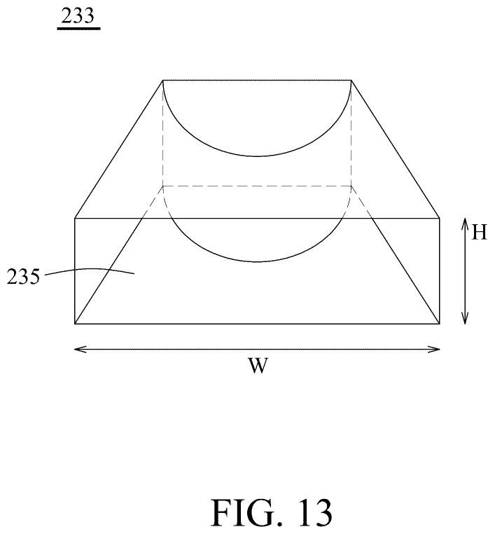

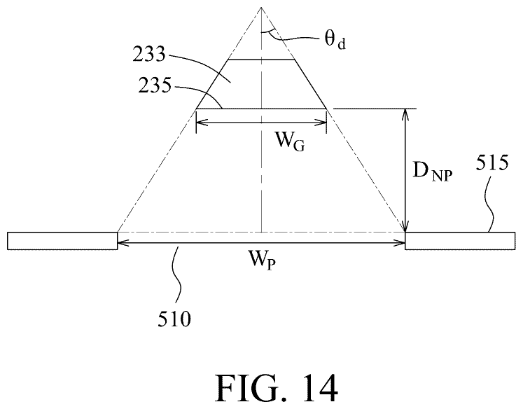

FIG. 11 illustrates a laser grooving apparatus in accordance with a third embodiment. The third embodiment is similar to the second embodiment, and differs from the second embodiment in that, as illustrated in FIG. 12, the purge component 23 of the third embodiment further has a nozzle portion 233 connected to the second straight tube portion 232 and the nozzle portion 233 has the gas outlet 235 of the purge component 23. In this embodiment, the second straight tube portion 232 extends obliquely from first straight tube portion 231 to the nozzle portion 233, and cooperates with the first straight tube portion 231 to deliver the purge gas to the nozzle portion 233. In this embodiment, the gas outlet 235 is elongated in shape (i.e., having a width greater than its height, such as a rectangle, an ellipse, or any other shapes fulfilling this condition). When the purge gas is expelled from the purge component 23, the elongated gas outlet 235 forms the purge gas into an air curtain that passes through the purge opening 510 and enters the exhaust channel. In comparison to the air column as generated in the first and second embodiments, the air curtain may be more effective in blocking the debris from passing through the purge opening 510. Further referring to FIG. 13, in accordance with some embodiments, a ratio of a width (W) of the gas outlet 235 to an inner diameter (Dₜ) of the straight tube portions 231, 232 is in a range from about 2.5 to about 3.5 (i.e., 2.5≤W/Dₜ≤3.5), and a ratio of a height of the gas outlet 235 to the inner diameter (Dₜ) of the straight tube portions 231, 232 is in a range from 0.3 to 0.7 (i.e., 0.3≤H/Dₜ≤0.7), so as to ensure sufficient strength of the air curtain while not increasing the difficulty in manufacturing the purge component 23 to a high standard. To fulfill the abovementioned condition, an aspect ratio of the gas outlet 235 (i.e., a ratio of the width (W) of the gas outlet 235 to the height (H) of the gas outlet 235) may range from about 3.5 to about 11.7 (i.e., 3.5≤W/H≤11.7). In accordance with some embodiments, a ratio of an area of the gas outlet 235 to an internal cross-sectional area of the straight tube portions 231, 232 is in a range from about 0.63 to about 1.86, so as to ensure sufficient strength of the air curtain while not increasing the difficulty in manufacturing the purge component 23 to a high standard. In accordance with some embodiments, the area of the gas outlet 235 is in a range from about 1.98 mm² to about 5.84 mm² for achieving the abovementioned effect. In accordance with some embodiments, the purge module 2 is configured in such a way that, when the purge component 23 is installed to the extending portion 21B, the first straight tube portion 231 extends horizontally, and the second straight tube portion 232 and the nozzle portion 233 extend obliquely downward toward the purge opening 510. In accordance with some embodiments, a widthwise direction of the gas outlet 235 is parallel to both of the surface of the wafer stage 6 and the purge opening 510, thereby optimizing the coverage of the air curtain over the purge opening 510. In accordance with some embodiments, taking into account a distance between the purge component 23 and the shield portion 21A of the purge module 2, a distance between the exhaust module 5 and the shield portion 21A of the purge module 2, and a distance between the purge component 23 and the purge opening 510, a bending angle θ_{b} of the purge component 23 (i.e., an angle between the second straight tube portion 232 and an extension line of the first straight tube portion 231) may be in a range from about 26 degrees to about 55 degrees. In accordance with some embodiments, a distance between the center of the gas outlet 235 to the center of the purge opening 510 is in a range from about 4.35 mm to about 6.52 mm, thereby ensuring that the expelled purge gas has sufficient strength to blow the debris deep inside the exhaust channel, while avoiding the risk of impeding the path of the laser beam. In accordance with some embodiments, the nozzle portion 233 extends in the same direction as the second straight tube portion 232. In accordance with some embodiments, the center of the gas outlet 235 is aligned with the center of the purge opening 510 in the direction the nozzle portion 233 extends. In accordance with some embodiments, an imaginary straight line connecting the center of the gas outlet 235 and the center of the purge opening 510 extends across the debris entry opening 511 and intersects the bottom plate 512 (see FIG. 5) of the exhaust module 5, so the purge gas expelled from the nozzle portion 233 would not pass through the debris entry opening 511 and would land on the bottom plate 512 of the exhaust module 5, thereby preventing the debris from being blown back onto the wafer 7 during the laser grooving. In accordance with some embodiments, the gas outlet 235 is smaller than the purge opening 510, and the nozzle portion 233 has a width that gradually increases from its gas inlet end (i.e., the end connected to the second straight tube portion 232) to the opposite end (i.e., the gas outlet 235), so the air curtain would expand at a divergence angle as it exits the nozzle portion 233. Further referring to FIG. 14, in accordance with some embodiments, the divergence angle θ_{d} of the air curtain is not smaller than tan⁻¹(0.9×(Wₚ−W_{g})/2D), where Wₚ represents the width of the purge opening 510, W_{g} represents the width of the gas outlet 235, and D represents a distance between the center of the gas outlet 235 and the center of the purge opening 510, so a width of the air curtain at the purge opening 510 is 90% or more of the width of the purge opening 510, thereby effectively reducing the amount of the debris passing through the purge opening 510. In accordance with some embodiments, the divergence angle θ_{d} of the air curtain is not smaller than tan⁻¹((Wₚ−W_{g})/2D), so the air curtain can completely cover the width of the purge opening 510.

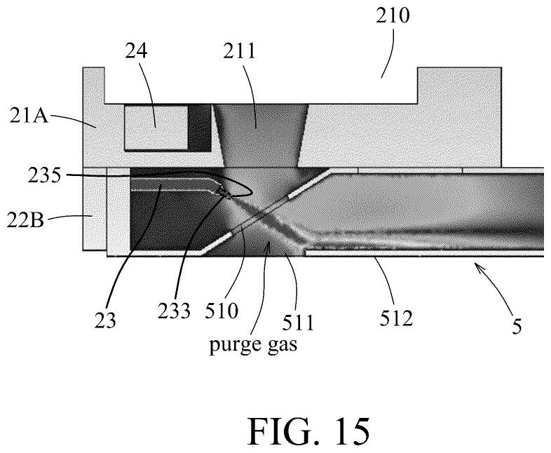

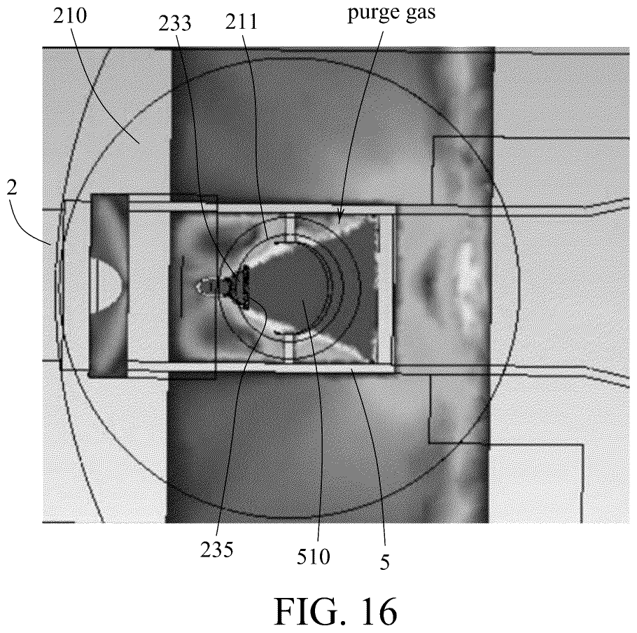

FIG. 15 and FIG. 16 are sectional views of the purge module 2 and the exhaust module 5 observed respectively from a lateral side and a top side, simulating a flow of the purge gas expelled from the purge component 23 of the third embodiment (see FIGS. 11 and 12). It is noted that the cross-section in FIG. 16 is not a horizontal section, but is an angled section cut along the direction the nozzle portion 233 extends. It can be seen from FIG. 15 that the purge gas is expelled obliquely downward, passes over the debris entry opening 511, and lands on the bottom plate 512 of the exhaust module 5, minimizing the contamination of the underlying wafer during the laser grooving. The downward flow of the purge gas can effectively weaken the upward movement of the debris, reducing the contamination of the protective lens 12 (see FIG. 11). In FIG. 16, it can be seen that although the gas outlet 235 is smaller than the purge opening in width (noting that in a case where the purge opening 510 is circular, the width of the purge opening 510 refers to a diameter of the purge opening 510), the purge gas expelled from the purge component 23 forms an air curtain that has a gradually increasing width. The distance between the purge component 23 and the purge opening 510, and the divergence angle of the purge gas is well designed such that the width of the air curtain is substantially the same as the width or the diameter of the purge opening 510 when the purge gas passes through the purge opening 510, optimizing the coverage of the purge gas over the purge opening 510.

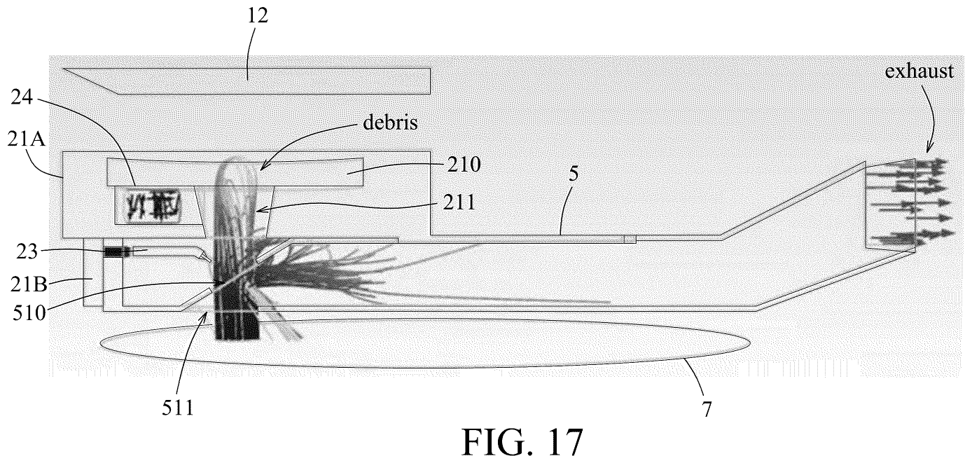

FIG. 17 is a sectional view of the purge module 2 and the exhaust module 3 of the third embodiment observed from a lateral side, simulating paths of gas particles that include the gas from the diffuser 24, the purge gas from the purge component 23, and the debris generated during the laser grooving process. The simulating condition is similar to that of FIG. 8, where a picosecond pulsed laser is used as the laser module 1. Compared to FIG. 8, it is obvious that the air curtain that flows diagonally downward effectively weakens the upward movement of the debris, and no debris reaches the protective lens 12 in the simulation.

In a variation of the third embodiment, the second straight tube portion 232 (see FIG. 12) may be omitted, and the purge component 23 includes the straight tube portion 231 and the nozzle portion 233 that is directly connected to the straight tube portion 231. Both of the straight tube portion 231 and the nozzle portion 232 extend horizontally toward the purge opening 510 when the purge component 23 is installed to the extending portion 21B of the purge module 2 (see FIG. 11), with the center of the gas outlet 235 being aligned or misaligned with the center of the purge opening 510 in the horizontal direction.

In a variation of the third embodiment, the first straight tube portion 231 may be omitted, and the second straight tube portion 232 is directly connected to the extending portion 21B of the purge module 2. The purge module 2 is configured in such a way that the straight tube portion 232 and the nozzle portion 233 extends obliquely downward toward the purge opening 510 when the purge component 23 is installed to the extending portion 21B of the purge module 2, with the center of the gas outlet 235 being aligned or misaligned with the center of the purge opening 510 in the direction the nozzle portion 233 extends.

In accordance with some embodiments, a debris removal module is provided to be adapted for a laser grooving apparatus that is configured to perform laser grooving on a wafer. The debris removal module includes a purge module and an exhaust module. The purge module includes a nozzle to expel a purge gas. The exhaust module has a debris entry opening disposed to receive debris generated from the wafer during the laser grooving, a purge opening disposed to receive the purge gas from the nozzle, and an exhaust channel disposed to exhaust the debris. The debris entry opening, the purge opening and the exhaust channel are in spatial communication. The nozzle has a gas outlet that faces the purge opening of the exhaust module, and the gas outlet is elongated in shape. The nozzle is configured to expel the purge gas through the gas outlet to push the debris toward the exhaust channel.

In accordance with some embodiments, the gas outlet has an aspect ratio in a range from 3.5 to 11.7.

In accordance with some embodiments, the purge module includes a gas delivering tube connected to the nozzle, and the gas delivering tube is configured to deliver the purge gas from a gas source to the nozzle. A ratio of a width of the gas outlet to an inner diameter of the gas delivering tube is in a range from 2.5 to 3.5, and a ratio of a height of the gas outlet to the inner diameter of the gas delivering tube is in a range from 0.3 to 0.7.

In accordance with some embodiments, the purge module includes a gas delivering tube connected to the nozzle, and the gas delivering tube is configured to deliver the purge gas from a gas source to the nozzle. A ratio of an area of the gas outlet of the nozzle to an internal cross-sectional area of the gas delivering tube is in a range from 0.63 to 1.86.

In accordance with some embodiments, a center of the gas outlet of the nozzle is aligned with a center of the purge opening in a direction the nozzle extends.

In accordance with some embodiments, the gas outlet is smaller than the purge opening, the nozzle is configured to expel the purge gas with a divergence angle that is not smaller than tan⁻¹(0.9×(W_{P}−W_{G})/2D), where W_{P} represents a width of the purge opening, W_{G} represents a width of the gas outlet, and D represents a distance between the center of the gas outlet of the nozzle and the center of the purge opening.

In accordance with some embodiments, the exhaust module is to be disposed above the wafer during the laser grooving, the purge module is disposed above the exhaust module, and the nozzle extends obliquely downward toward the purge opening of the exhaust module.

In accordance with some embodiments, the exhaust module has a slanted surface facing obliquely upward toward the gas outlet of the nozzle and having the purge opening, and the purge opening is, at least in part, aligned with the debris entry opening in a vertical direction, thereby allowing a laser beam emitted by a laser source of the laser grooving apparatus to pass through the exhaust module and reach the wafer.

In accordance with some embodiments, the debris entry opening is located at a bottom of the exhaust module, and an imaginary straight line connecting the center of the gas outlet of the nozzle and the center of the purge opening extends across the debris entry opening and intersects the bottom of the exhaust module.

In accordance with some embodiments, the purge module includes a gas delivering tube connected to the nozzle, and the gas delivering tube is configured to deliver the purge gas from a gas source to the nozzle. The gas delivering tube includes a first portion extending parallel to a top surface of the wafer during the laser grooving, and a second portion extending obliquely downward from the first portion of the gas delivering tube to the nozzle.

In accordance with some embodiments, an angle between the first portion and the second portion of the gas delivering tube is in a range from 26 degrees to 55 degrees.

In accordance with some embodiments, a debris removal module is provided to be adapted for a laser grooving apparatus that is configured to perform laser grooving on a wafer. The debris removal module includes an exhaust module and a purge module. The exhaust module is to be disposed above the wafer during the laser grooving, and has a debris entry opening and a purge opening. The purge module includes a nozzle configured to create an air curtain passing through the purge opening. The debris entry opening and the purge opening are in spatial communication, and are disposed to allow passage of a laser beam through the exhaust module during the laser grooving. The debris entry opening is closer to the wafer than the purge opening during the laser grooving.

In accordance with some embodiments, the nozzle of the purge module is configured in such a way that the air curtain does not pass through the debris entry opening.

In accordance with some embodiments, the nozzle of the purge module is configured in such a way that the air curtain passes through a center of the purge opening.

In accordance with some embodiments, the nozzle of the purge module is configured in such a way that a width of the air curtain at the purge opening is not smaller than 0.9 times a width of the purge opening.

In accordance with some embodiments, the nozzle extends obliquely downward toward the purge opening, thereby making the air curtain flow obliquely downward into the purge opening.

In accordance with some embodiments, the debris entry opening is parallel to the wafer during the laser grooving, and the purge opening is slanted relative to the debris entry opening.

In accordance with some embodiments, a laser grooving apparatus is provided to include a wafer stage configured to hold a wafer, a laser module configured to emit a laser beam onto the wafer that is disposed on the wafer stage, an exhaust module disposed between the wafer stage and the laser module, and a purge module. The exhaust module has a debris entry opening, a purge opening and an exhaust channel that are in spatial communication. The debris entry opening is disposed to allow passage of the laser beam and to receive debris generated from the wafer during the laser grooving, the purge opening is disposed to allow passage of the laser beam, and the exhaust channel is disposed to exhaust the debris. The purge module includes a nozzle to expel a purge gas toward the purge opening and the exhaust channel. The nozzle has a gas outlet that is elongated in shape, thereby forming the purge gas into an air curtain that passes through the purge opening.

In accordance with some embodiments, the nozzle extends obliquely downward toward the purge opening, thereby making the air curtain flow obliquely downward into the purge opening.

In accordance with some embodiments, a widthwise direction of the gas outlet is parallel to both a surface of the wafer stage and the purge opening.

In accordance with some embodiments, a laser grooving method is provided. In one step, a package wafer is loaded onto a wafer stage. In one step, a laser source is heated to perform a grooving process on a scribe line between adjacent circuit dies on the package wafer. In one step, debris generated from the grooving process is collected using a debris exhaust module. The debris exhaust module is disposed between the wafer stage and the laser source, and has a debris entry opening adjacent to the wafer stage, a purge opening disposed above and in spatial communication with the debris entry opening, and a purge tube expelling an air curtain toward the purge opening.

In accordance with some embodiments, the purge tube expels the air curtain obliquely downward toward the purge opening during the collecting of the debris.

In accordance with some embodiments, the purge tube is an angled tube, and the debris entry opening is a rectangle opening.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A debris removal module adapted for a laser grooving apparatus that is configured to perform laser grooving on a wafer, comprising:
a purge module that includes a nozzle to expel a purge gas; and
an exhaust module that has a debris entry opening disposed to receive debris generated from the wafer during the laser grooving, a purge opening disposed to receive the purge gas from the nozzle, and an exhaust channel disposed to exhaust the debris;
wherein the debris entry opening, the purge opening and the exhaust channel are in spatial communication;
wherein the nozzle has a gas outlet that faces the purge opening of the exhaust module, and the gas outlet is elongated in shape; and
wherein the nozzle is configured to expel the purge gas through the gas outlet to push the debris toward the exhaust channel.

2. The debris removal module according to claim 1, wherein the gas outlet has an aspect ratio in a range from 3.5 to 11.7.

3. The debris removal module according to claim 1, wherein the purge module includes a gas delivering tube connected to the nozzle, and the gas delivering tube is configured to deliver the purge gas from a gas source to the nozzle; and
wherein a ratio of a width of the gas outlet to an inner diameter of the gas delivering tube is in a range from 2.5 to 3.5, and a ratio of a height of the gas outlet to the inner diameter of the gas delivering tube is in a range from 0.3 to 0.7.

4. The debris removal module according to claim 1, wherein the purge module includes a gas delivering tube connected to the nozzle, and the gas delivering tube is configured to deliver the purge gas from a gas source to the nozzle; and
wherein a ratio of an area of the gas outlet of the nozzle to an internal cross-sectional area of the gas delivering tube is in a range from 0.63 to 1.86.

5. The debris removal module according to claim 1, wherein a center of the gas outlet of the nozzle is aligned with a center of the purge opening in a direction the nozzle extends.

6. The debris removal module according to claim 5, wherein the gas outlet is smaller than the purge opening, the nozzle is configured to expel the purge gas with a divergence angle that is not smaller than tan⁻¹(0.9×(W_{P}−W_{G})/2D), where W_{P} represents a width of the purge opening, W_{G} represents a width of the gas outlet, and D represents a distance between the center of the gas outlet of the nozzle and the center of the purge opening.

7. The debris removal module according to claim 5, wherein the exhaust module is to be disposed above the wafer during the laser grooving, the purge module is disposed above the exhaust module, and the nozzle extends obliquely downward toward the purge opening of the exhaust module.

8. The debris removal module according to claim 7, wherein the exhaust module has a slanted surface facing obliquely upward toward the gas outlet of the nozzle and having the purge opening, and the purge opening is, at least in part, aligned with the debris entry opening in a vertical direction, thereby allowing a laser beam emitted by a laser source of the laser grooving apparatus to pass through the exhaust module and reach the wafer.

9. The debris removal module according to claim 8, wherein the debris entry opening is located at a bottom of the exhaust module, and an imaginary straight line connecting the center of the gas outlet of the nozzle and the center of the purge opening extends across the debris entry opening and intersects the bottom of the exhaust module.

10. The debris removal module according to claim 7, wherein the purge module includes a gas delivering tube connected to the nozzle, and the gas delivering tube is configured to deliver the purge gas from a gas source to the nozzle; and
wherein the gas delivering tube includes a first portion extending parallel to a top surface of the wafer during the laser grooving, and a second portion extending obliquely downward from the first portion of the gas delivering tube to the nozzle.

11. The debris removal module according to claim 10, wherein an angle between the first portion and the second portion of the gas delivering tube is in a range from 26 degrees to 55 degrees.

12. A debris removal module adapted for a laser grooving apparatus that is configured to perform laser grooving on a wafer, comprising:
an exhaust module that is to be disposed above the wafer during the laser grooving, and that has a debris entry opening and a purge opening; and
a purge module that includes a nozzle configured to create an air curtain passing through the purge opening;
wherein the debris entry opening and the purge opening are in spatial communication, and are disposed to allow passage of a laser beam through the exhaust module during the laser grooving; and
wherein the debris entry opening is closer to the wafer than the purge opening during the laser grooving.

13. The debris removal module according to claim 12, wherein the nozzle of the purge module is configured in such a way that the air curtain does not pass through the debris entry opening.

14. The debris removal module according to claim 12, wherein the nozzle of the purge module is configured in such a way that the air curtain passes through a center of the purge opening.

15. The debris removal module according to claim 14, wherein the nozzle of the purge module is configured in such a way that a width of the air curtain at the purge opening is not smaller than 0.9 times a width of the purge opening.

16. The debris removal module according to claim 12, wherein the nozzle extends obliquely downward toward the purge opening, thereby making the air curtain flow obliquely downward into the purge opening.

17. The debris removal module according to claim 13, wherein the debris entry opening is parallel to the wafer during the laser grooving, and the purge opening is slanted relative to the debris entry opening.

18. A wafer grooving method, comprising:
loading a package wafer onto a wafer stage;
heating a laser source to perform a grooving process on a scribe line between adjacent circuit dies on the package wafer; and
collecting debris generated from the grooving process using a debris exhaust module,
wherein the debris exhaust module disposed between the wafer stage and the laser source, and has a debris entry opening adjacent to the wafer stage, a purge opening disposed above and in spatial communication with the debris entry opening, and a purge tube expelling an air curtain toward the purge opening.

19. The wafer grooving method according to claim 18, wherein, during the collecting of the debris, the purge tube expels the air curtain obliquely downward toward the purge opening.

20. The wafer grooving method according to claim 18, wherein the purge tube is an angled tube, and the debris entry opening is a rectangle opening.
